(19) United States
(12) Patent Application Publication
(10) Pub. No.: US 2016/0344236 A1
(43) Pub. Date: Nov. 24, 2016

(54) CONTACTLESS POWER TRANSMISSION DEVICE AND POWER TRANSFER SYSTEM

(71) Applicant: TOYOTA JIDOSHA KABUSHIKI KAISHA, Toyota-shi (JP)

(72) Inventor: Takahiro MISAWA, Okazaki-shi (JP)

(73) Assignee: TOYOTA JIDOSHA KABUSHIKI KAISHA, Toyota-shi (JP)

(21) Appl. No.: 15/130,413

(22) Filed: Apr. 15, 2016

(30) Foreign Application Priority Data
May 21, 2015 (JP) 2015-103698

(51) Int. Cl. H02J 50/10; H02M 1/36; H02M 7/5375

(52) U.S. Cl. CPC H02J 50/10; H02M 7/5375; H02M 1/36

(57) ABSTRACT

A power supply ECU executes transmission power control for controlling transmission power to target power by adjusting the duty of an output voltage of an inverter and turn-on current control for controlling a turn-on current to a target value by adjusting the drive frequency of the inverter. The target value for the turn-on current is set to fall within a range where a recovery current is not produced in a freewheel diode of the inverter. The power supply ECU executes each control such that a responsivity of the transmission power control becomes higher than that of the turn-on current control during the execution of startup processing of the inverter.

This nonprovisional application is based on Japanese Patent Application 2015-103698 filed on May 21, 2015 with the Japan Patent Office, the entire contents of which are hereby incorporated by reference.

### BACKGROUND OF THE INVENTION

1. Field of the Invention

The present invention relates to a contactless power transmission device and a power transfer system, and particularly to a power control technique in a contactless power transmission device that transmits electric power to a power reception device in a contactless manner.

2. Description of the Background Art

Japanese Patent Laying-Open No. 2014-207795 discloses a contactless power feeding system that supplies electric power from a power feeding device (power transmission device) to a vehicle (power reception device) in a contactless manner. In this contactless power feeding system, the power feeding device includes a power transmission coil, an inverter and a control unit. The power transmission coil transmits electric power to the power reception coil mounted on the vehicle in a contactless manner. The inverter produces an AC current in accordance with a drive frequency for output to the power transmission coil. The control unit obtains a charging power command for a battery and output power for the battery from the vehicle side, and controls by feedback the drive frequency of the inverter such that the output power follows the charging power command.

In this contactless power feeding system, when power supply from the power feeding device to the vehicle is started, the initial frequency is set based on the battery state and the coupling coefficient between coils (power transmission coil and power reception coil), and the above-described feedback control is started using the initial frequency as the initial value of the drive frequency (see Japanese Patent Laying-Open No. 2014-207795).

When the inverter is a voltage-source inverter and supplies transmission power in accordance with the drive frequency to the power transmission unit, transmission power can be controlled by adjusting the duty of an inverter output voltage. By controlling the drive frequency of the inverter, a turn-on current indicating an inverter output current at the rising of the inverter output voltage can be controlled.

It is known that in the voltage-source inverter, if an output current of the same sign as the output voltage (i.e. positive turn-on current) flows at the rising of the output voltage, a recovery current flows into freewheel diodes of the inverter. When a recovery current flows, the freewheel diodes generate heat, resulting in increase in losses. Therefore, by controlling the drive frequency of the inverter to control the turn-on current to be less than or equal to 0, losses caused by the recovery current can be suppressed.

In executing control as described above, it is an object to prevent a recovery current from flowing into the inverter as much as possible at the time when inverter startup processing or stop processing is executed. Japanese Patent Laying-Open No. 2014-207795 fails to particularly study such a problem and a solution therefor.

### SUMMARY OF THE INVENTION

The present invention was made to solve such a problem, and has an object to provide a contactless power transmission device that transmits electric power to a power reception device in a contactless manner, in which a recovery current is prevented from flowing into an inverter as much as possible at the time when inverter startup processing or stop processing is executed.

Another object of the present invention is to provide a power transfer system that transmits electric power from a power transmission device to a power reception device in a contactless manner, in which a recovery current is prevented from flowing into an inverter as much as possible at the time when the inverter startup processing or stop processing is executed.

According to the present invention, a contactless power transmission device includes a power transmission unit, a voltage-source inverter and a control unit that controls the inverter. The power transmission unit is configured to transmit electric power to a power reception device in a contactless manner. The inverter supplies transmission power in accordance with a drive frequency to the power transmission unit. The control unit executes a first control and a second control. The first control is to control the transmission power to target power by adjusting a duty of an output voltage of the inverter (transmission power control). The second control is to control a turn-on current to a target value by adjusting the drive frequency (turn-on current control). The turn-on current indicates an output current of the inverter at a rising of the output voltage. The target value is set to fall within a range where a recovery current is not produced in a freewheel diode of the inverter. The control unit executes the first and second controls such that a responsivity of the first control becomes higher than a responsivity of the second control during the execution of startup processing of the inverter.

Preferably, the control unit makes a control gain of the first control higher than a control gain of the second control during the execution of the inverter startup processing.

At the time when the inverter is started up, the duty of the inverter output voltage rises from 0, and transmission power increases accordingly. There is an operating area where the turn-on current cannot be controlled to be less than or equal to 0 even by the second control (turn-on current control) (i.e., an operating area where a recovery current is produced). This area tends to be extended when the duty is small. Therefore, in the present invention, the responsivity of the first control (transmission power control) is made higher than the responsivity of the second control (turn-on current control) when the inverter startup processing is executed. For example, the control gain of the first control is made higher than the control gain of the second control when the inverter startup processing is executed. Accordingly, the duty can be raised quickly from 0 when the inverter startup processing is executed, allowing the operating point to pass quickly through the area where a recovery current is produced. Therefore, according to the present invention, a recovery current can be prevented from flowing into the inverter as much as possible when the inverter startup processing is executed.

The target value for the turn-on current is set at a predetermined value of less than or equal to 0, for example, that falls within the range where a recovery current is not produced in the freewheel diode of the inverter.

Preferably, the control unit further executes the first and second controls such that the responsivity of the second control becomes higher than the responsivity of the first control during the execution of stop processing of the inverter.

More preferably, the control unit makes a control gain of the second control higher than the control gain of the first control during the execution of the inverter stop processing.

At the time of stopping the inverter, the duty of the inverter output voltage is reduced, and transmission power is reduced accordingly. Here, as described above, the operating area where a recovery current is produced tends to be extended when the duty is small. Therefore, in the present invention, the responsivity of the second control (turn-on current control) is made higher than the responsivity of the first control (transmission power control) when the inverter stop processing is executed. For example, the control gain of the second control is made higher than the control gain of the first control when the inverter stop processing is executed. Accordingly, when the inverter stop processing is executed, the duty can be reduced to reduce transmission power while avoiding the area where a recovery current is produced as much as possible. Therefore, according to the present invention, a recovery current can be prevented from flowing into the inverter as much as possible when the inverter stop processing is executed.

Preferably, the control unit executes the first and second controls such that the responsivity of the first control during the execution of the inverter startup processing becomes higher than the responsivity of the first control during the execution of the inverter stop processing.

More preferably, the control unit makes the control gain of the first control during the execution of the inverter startup processing higher than a control gain of the first control during the execution of the inverter stop processing.

In the present invention, the responsivity of the first control is made higher when the inverter startup processing is executed. This allows the operating point to pass quickly through the area where a recovery current is produced when the inverter startup processing is executed. Therefore, according to the present invention, a recovery current can be prevented from flowing into the inverter as much as possible when the inverter startup processing is executed.

Preferably, the control unit executes the first and second controls such that the responsivity of the second control during the execution of the inverter stop processing becomes higher than the responsivity of the second control during the execution of the inverter startup processing.

More preferably, the control unit makes the control gain of the second control during the execution of the inverter stop processing higher than a control gain of the second control during the execution of the inverter startup processing.

In the present invention, the responsivity of the second control is made higher when the inverter stop processing is executed. Accordingly, transmission power can be reduced while avoiding the area where a recovery current is produced as much as possible when the inverter stop processing is executed. Therefore, according to the present invention, a recovery current can be prevented from flowing into the inverter as much as possible when the inverter stop processing is executed.

According to the present invention, a power transfer system includes a power transmission device and a power reception device. The power transmission device includes a power transmission unit, a voltage-source inverter and a control unit that controls the inverter. The power transmission unit is configured to transmit electric power to the power reception device in a contactless manner. The inverter supplies transmission power in accordance with a drive frequency to the power transmission unit. The control unit executes a first control and a second control. The first control is to control the transmission power to target power by adjusting a duty of an output voltage of the inverter (transmission power control). The second control is to control a turn-on current to a target value by adjusting the drive frequency (turn-on current control). The turn-on current indicates an output current of the inverter at a rising of the output voltage. The target value is set to fall within a range where a recovery current is not produced in a freewheel diode of the inverter (a predetermined value of less than or equal to 0). The control unit executes the first and second controls such that a responsivity of the first control becomes higher than a responsivity of the second control during the execution of startup processing of the inverter.

Preferably, the control unit further executes the first and second controls such that the responsivity of the second control becomes higher than the responsivity of the first control during the execution of stop processing of the inverter.

Preferably, the control unit executes the first and second controls such that the responsivity of the first control during the execution of the inverter startup processing becomes higher than the responsivity of the first control during the execution of the inverter stop processing.

Preferably, the control unit executes the first and second controls such that the responsivity of the second control during the execution of the inverter stop processing becomes higher than the responsivity of the second control during the execution of the inverter startup processing.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an overall configuration of a power transfer system to which a contactless power transmission device according to a first embodiment of the present invention is applied.

FIG. 2 illustrates an example of a circuit configuration of a power transmission unit and a power reception unit shown in FIG. 1.

FIG. 3 illustrates a circuit configuration of an inverter shown in FIG. 1.

FIG. 4 illustrates switching waveforms of the inverter as well as waveforms of an output voltage and an output current.

FIG. 5 is a control block diagram of transmission power control and turn-on current control executed by a power supply ECU.

FIG. 6 illustrates an example of contour lines of transmission power and a turn-on current.

FIG. 7 is a flowchart showing a procedure of inverter startup processing executed by the power supply ECU.

FIG. 8 illustrates an example of contour lines of transmission power and a turn-on current.

FIG. 9 is a flowchart showing a procedure of inverter stop processing executed by a power supply ECU according to a second embodiment.

### DESCRIPTION OF THE PREFERRED EMBODIMENTS

Hereinafter, embodiments of the present invention will be described in detail with reference to the drawings. Although a plurality of embodiments will be described below, an appropriate combination of features described in the respective embodiments is encompassed at the time of filing of the application. In the drawings, the same or corresponding portions have the same reference characters allotted, and description thereof will not be repeated.

### First Embodiment

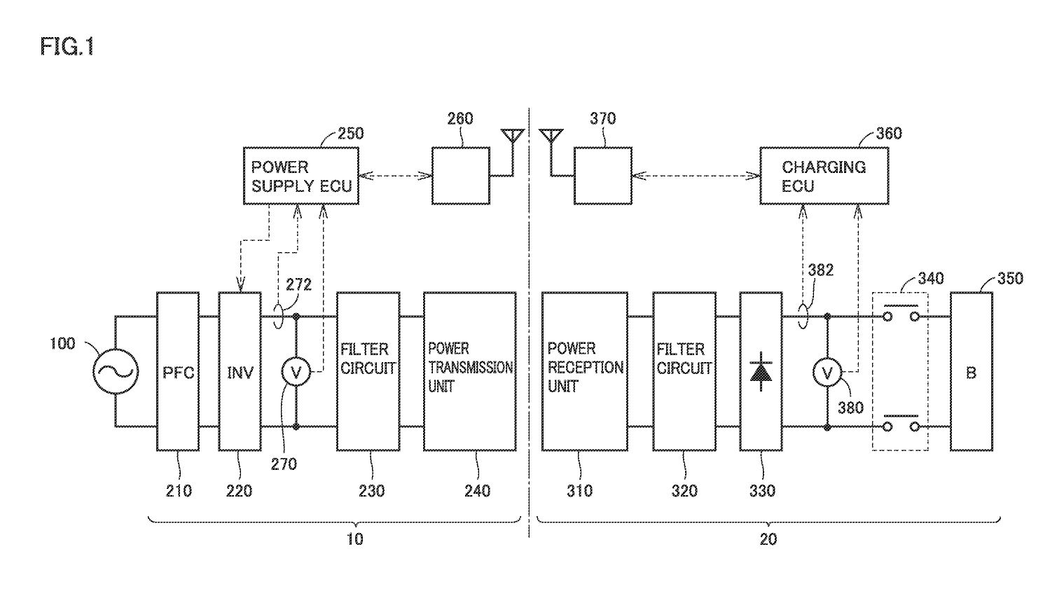

FIG. 1 shows an overall configuration of a power transfer system to which a contactless power transmission device according to a first embodiment of the present invention is applied. Referring to FIG. 1, this power transfer system includes a power transmission device 10 and a power reception device 20. Power reception device 20 may be mounted on a vehicle or the like that can travel using electric power supplied from power transmission device 10 and stored therein, for example.

Power transmission device 10 includes a power factor correction (PFC) circuit 210, an inverter 220, a filter circuit 230, and a power transmission unit 240. Power transmission device 10 further includes a power supply ECU (Electronic Control Unit) 250, a communication unit 260, a voltage sensor 270, and a current sensor 272.

PFC circuit 210 can rectify and boost AC power received from an AC power supply 100 (e.g., system power supply) for supply to inverter 220 and can bring an input current close to a sine wave, thereby correcting the power factor. Any of publicly known various PFC circuits can be adopted as this PFC circuit 210. Instead of PFC circuit 210, a rectifier without the power factor correcting function may be adopted.

Inverter 220 converts DC power received from PFC circuit 210 into transmission power (AC) having a predetermined transmission frequency. The transmission power produced by inverter 220 is supplied to power transmission unit 240 through filter circuit 230. Inverter 220 is a voltage-source inverter, in which a freewheel diode is connected in antiparallel to each of switching elements that constitute inverter 220. Inverter 220 is implemented by a single-phase full bridge circuit, for example.

Filter circuit 230 is provided between inverter 220 and power transmission unit 240, and suppresses a harmonic noise caused by inverter 220. Filter circuit 230 is implemented by an LC filter including an inductor and a capacitor, for example.

Power transmission unit 240 receives AC power (transmission power) having a transmission frequency from inverter 220 through filter circuit 230, and transmits the electric power in a contactless manner to a power reception unit 310 of power reception device 20 through an electromagnetic field produced around power transmission unit 240. Power transmission unit 240 includes a resonant circuit for transmitting electric power to power reception unit 310 in a contactless manner, for example. Although the resonant circuit may be composed of a coil and a capacitor, the capacitor may be omitted when a desired resonant state is achieved only with the coil.

Voltage sensor 270 detects an output voltage of inverter 220 (equivalent to a voltage of transmission power supplied to power transmission unit 240), and outputs a detected value to power supply ECU 250. Current sensor 272 detects an output current of inverter 220 (equivalent to a current of transmission power supplied to power transmission unit 240), and outputs a detected value to power supply ECU 250. Based on the detected values of voltage sensor 270 and current sensor 272, transmission power supplied from inverter 220 to power transmission unit 240 (i.e., electric power output from power transmission unit 240 to power reception device 20) can be detected. Voltage sensor 270 and current sensor 272 may be provided between filter circuit 230 and power transmission unit 240.

Power supply ECU 250, including a CPU (Central Processing Unit), a memory device, an input/output buffer, and the like (neither shown), receives signals from various sensors and devices, and controls various devices in power transmission device 10. As an example, power supply ECU 250 exerts switching control of inverter 220 such that inverter 220 produces transmission power (AC) when power transmission from power transmission device 10 to power reception device 20 is executed. Various types of controls are not limited to processing by software, but may be processed by dedicated hardware (an electronic circuit).

As main control executed by power supply ECU 250, power supply ECU 250 executes feedback control (hereinafter also referred to as “transmission power control”) for controlling transmission power to target power when power transmission from power transmission device 10 to power reception device 20 is executed. Specifically, power supply ECU 250 controls transmission power to target power by adjusting the duty of an output voltage of inverter 220. The duty of an output voltage is defined as a ratio of a positive (or negative) voltage output time period to the cycle of an output voltage waveform (square wave). The duty of an inverter output voltage can be adjusted by changing the operating timing of the switching elements of inverter 220 (on/off duty: 0.5). Target power may be produced based on the power reception state of power reception device 20, for example. In this first embodiment, power reception device 20 produces target power for transmission power based on a deflection between a target value and a detected value of received power, and transmits the target power to power transmission device 10.

Power supply ECU 250 executes feedback control for controlling a turn-on current in inverter 220 to a target value (hereinafter also referred to as “turn-on current control”) while executing the above-described transmission power control. The turn-on current is an instantaneous value of the output current of inverter 220 at the rising of the output voltage of inverter 220. If the turn-on current has a positive value, a reverse recovery current flows into the freewheel diodes of inverter 220, causing heat generation, namely, losses, in the freewheel diodes. Therefore, the above-described target value for the turn-on current control (turn-on current target value) is set to fall within the range where a recovery current is not produced in the freewheel diodes of inverter 220, and is set at a predetermined value of less than or equal to 0 (“0” at which the power factor is improved is ideal, but a negative value may also be selected affording a margin). The transmission power control and turn-on current control will be described later in detail.

Communication unit 260 is configured to make wireless communications with a communication unit 370 of power reception device 20, and receives a target value for transmission power (target power) transmitted from power reception device 20, and also exchanges information including start/stop of power transmission, the power reception state of power reception device 20, and the like with power reception device 20.

On the other hand, power reception device 20 includes power reception unit 310, a filter circuit 320, a rectification unit 330, a relay circuit 340, and a power storage device 350. Power reception device 20 further includes a charging ECU 360, communication unit 370, a voltage sensor 380, and a current sensor 382.

Power reception unit 310 receives electric power (AC) output from power transmission unit 240 of power transmission device 10 in a contactless manner. Power reception unit 310 includes a resonant circuit for receiving electric power from power transmission unit 240 in a contactless manner, for example. Although the resonant circuit may be composed of a coil and a capacitor, the capacitor may be omitted when a desired resonant state is achieved only with the coil. Power reception unit 310 outputs received power to rectification unit 330 through filter circuit 320.

Filter circuit 320 is provided between power reception unit 310 and rectification unit 330, and suppresses a harmonic noise produced at the time of power reception. Filter circuit 320 is implemented by an LC filter including an inductor and a capacitor, for example. Rectification unit 330 rectifies AC power received by power reception unit 310 for output to power storage device 350.

Power storage device 350 is a rechargeable DC power supply, and is implemented by a secondary battery, such as a lithium-ion battery or a nickel-metal hydride battery, for example. Power storage device 350 stores electric power output from rectification unit 330. Power storage device 350 then supplies the stored electric power to a load driving device or the like not shown. A large-capacity capacitor can also be adopted as power storage device 350.

Relay circuit 340 is provided between rectification unit 330 and power storage device 350, and is turned on when power storage device 350 is charged by power transmission device 10. Although not particularly shown, a DC/DC converter that adjusts an output voltage of rectification unit 330 may be provided between rectification unit 330 and power storage device 350 (e.g., between rectification unit 330 and relay circuit 340).

Voltage sensor 380 detects an output voltage (a voltage of received power) of rectification unit 330, and outputs the detected value to charging ECU 360. Current sensor 382 detects an output current (a current of received power) from rectification unit 330, and outputs the detected value to charging ECU 360. Based on the detected values of voltage sensor 380 and current sensor 382, electric power received by power reception unit 310 (i.e., charging power for power storage device 350) can be detected. Voltage sensor 380 and current sensor 382 may be provided between power reception unit 310 and rectification unit 330 (e.g., between filter circuit 320 and rectification unit 330).

Charging ECU 360, including a CPU, a memory device, an input/output buffer, and the like (neither shown), receives signals from various sensors and devices, and controls various devices in power reception device 20. Various types of controls are not limited to processing by software, but may be processed by dedicated hardware (an electronic circuit).

As main control executed by charging ECU 360, during power reception from power transmission device 10, charging ECU 360 produces a target value for transmission power (target power) in power transmission device 10 such that received power in power reception device 20 attains a desired target value. Specifically, charging ECU 360 produces the target value for transmission power in power transmission device 10 based on the deflection between the detected value and the target value for received power. Charging ECU 360 then transmits the produced target value for transmission power (target power) to power transmission device 10 through communication unit 370.

Communication unit 370 is configured to make wireless communications with communication unit 260 of power transmission device 10, and transmits the target value for transmission power (target power) produced in charging ECU 360 to power transmission device 10, exchanges information on start/stop of power transmission with power transmission device 10, and transmits the power reception state of power reception device 20 (a voltage of received power, a current of received power, received power, etc.) to power transmission device 10.

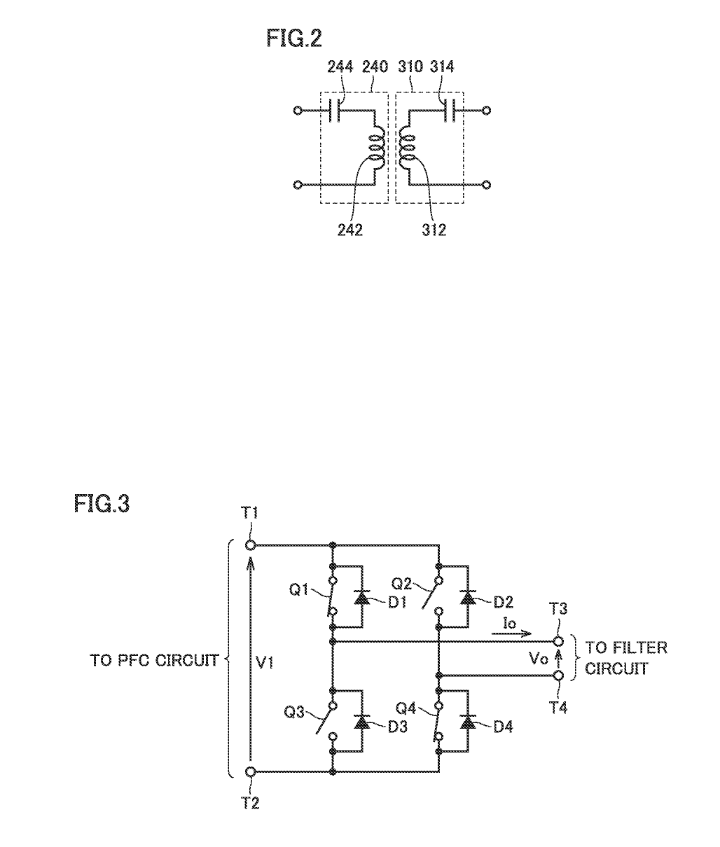

FIG. 2 illustrates an example of a circuit configuration of power transmission unit 240 and power reception unit 310 shown in FIG. 1. Referring to FIG. 2, power transmission unit 240 includes a coil 242 and a capacitor 244. Capacitor 244 is provided to compensate for the power factor of transmission power, and is connected in series with coil 242. Power reception unit 310 includes a coil 312 and a capacitor 314. Capacitor 314 is provided to compensate for the power factor of received power, and is connected in series with coil 312. Such a circuit configuration is also called an SS (primary series-secondary series) arrangement.

Although not particularly shown, the configuration of power transmission unit 240 and power reception unit 310 is not limited to that of the SS arrangement. For example, an SP (primary series-secondary parallel) arrangement with which capacitor 314 is connected in parallel with coil 312 in power reception unit 310 may be adopted, or a PP (primary parallel-secondary parallel) arrangement with which capacitor 244 is further connected in parallel with coil 242 in power transmission unit 240 may be adopted.

Referring again to FIG. 1, in this power transfer system, transmission power

(AC) is supplied from inverter 220 to power transmission unit 240 through filter circuit 230. Power transmission unit 240 and power reception unit 310 each include a coil and a capacitor, and are designed to resonate at a transmission frequency. The Q factor indicating the resonance strength of power transmission unit 240 and power reception unit 310 is preferably more than or equal to 100.

In power transmission device 10, when transmission power is supplied from inverter 220 to power transmission unit 240, energy (electric power) is transferred from power transmission unit 240 to power reception unit 310 through an electromagnetic field formed between the coil of power transmission unit 240 and the coil of power reception unit 310. The energy (electric power) transferred to power reception unit 310 is supplied to power storage device 350 through filter circuit 320 and rectification unit 330.

FIG. 3 illustrates a circuit configuration of inverter 220 shown in FIG. 1. Referring to FIG. 3, inverter 220 is a voltage-source inverter, and includes power semiconductor switching elements Q1 to Q4 (hereinafter briefly referred to as “switching elements” as well) and freewheel diodes D1 to D4. PFC circuit 210 (FIG. 1) is connected to terminals T1 and T2 on the DC side, and filter circuit 230 is connected to terminals T3 and T4 on the AC side.

Switching elements Q1 to Q4 are implemented by, for example, IGBTs (Insulated Gate Bipolar Transistors), bipolar transistors, MOSFETs (Metal Oxide Semiconductor Field Effect Transistors), GTOs (Gate Turn Off thyristors), or the like. Freewheel diodes D1 to D4 are connected in antiparallel to switching elements Q1 to Q4, respectively.

A DC voltage V1 output from PFC circuit 210 is applied across terminal T1 and T2. Following the switching operation of switching elements Q1 to Q4, an output voltage Vo and an output current Io are produced across terminals T3 and T4 (the direction indicated by each arrow in the figure shall indicate a positive value). This FIG. 3 shows, as an example, a state where switching elements Q1 and Q4 are on, and switching elements Q2 and Q3 are off. Output voltage Vo in this case is substantially equal to voltage V1 (positive value).

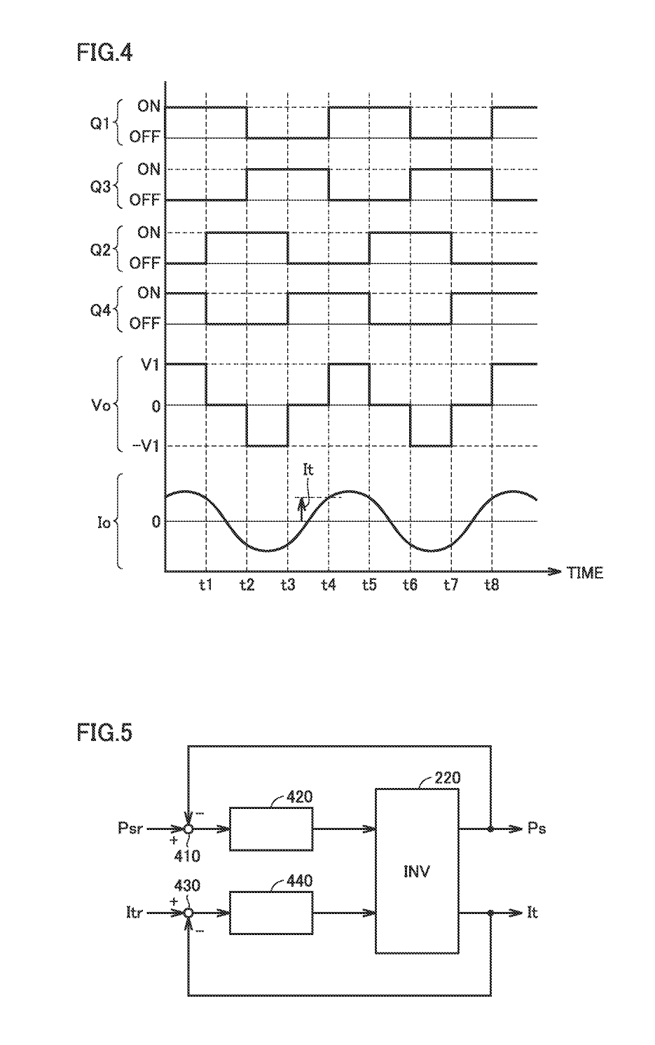

FIG. 4 illustrates switching waveforms of inverter 220 as well as waveforms of output voltage Vo and output current Io. Referring to FIG. 3 along with FIG. 4, one cycle from time t4 to time t8 will be described by way of example. At time t4, with switching elements Q2 and Q4 being off and on, respectively, switching element Q1 is switched from off to on, and switching element Q3 is switched from on to off (the state shown in FIG. 3). Then, output voltage Vo of inverter 220 rises from 0 to V1 (positive value).

At time t5, with switching elements Q1 and Q3 being on and off, respectively, switching element Q2 is switched from off to on, and switching element Q4 is switched from on to off. Then, output voltage Vo becomes 0.

At time t6, with switching elements Q2 and Q4 being on and off, respectively, switching element Q1 is switched from on to off, and switching element Q3 is switched from off to on. Then, output voltage Vo becomes −V1 (negative value).

At time t7, with switching elements Q1 and Q3 being off and on, respectively, switching element Q2 is switched from on to off, and switching element Q4 is switched from off to on. Then, output voltage Vo recovers to 0.

Then, at time t8 after one cycle from time t4, with switching elements Q2 and Q4 being off and on, respectively, switching element Q1 is switched from off to on, and switching element Q3 is switched from on to off. Then, output voltage Vo rises from 0 to V1 (positive value) (the state identical to that of time t4).

FIG. 4 shows the case where the duty of output voltage Vo is 0.25. The duty of output voltage Vo can be varied by changing the switching timing of switching elements Q1, Q3 and that of switching elements Q2 and Q4. For example, when the switching timing of switching elements Q2 and Q4 is accelerated relative to the case shown in FIG. 4, the duty of output voltage Vo can be made lower than 0.25 (0 at minimum), and when the switching timing of switching elements Q2 and Q4 is delayed, the duty of output voltage Vo can be made higher than 0.25 (0.5 at maximum).

Transmission power can be varied by adjusting this duty of output voltage Vo. Qualitatively, transmission power can be increased by increasing the duty, and can be reduced by decreasing the duty. Therefore, in this first embodiment, power supply ECU 250 executes transmission power control for controlling transmission power to target power by adjusting the duty of output voltage Vo.

An instantaneous value It of output current Io at the rising of output voltage Vo (time t4 and time t8) is equivalent to the above-described turn-on current. The value of this turn-on current It varies with voltage V1 supplied to inverter 220 from PFC circuit 210 or the drive frequency (switching frequency) of inverter 220. Shown here is the case where positive turn-on current It flows.

When positive turn-on current It flows, a reverse current, namely, a recovery current flows into freewheel diode D3 (FIG. 3) connected in antiparallel to switching element Q3. When the recovery current flows into freewheel diode D3, heat generation in freewheel diode D3 increases, causing increase in losses in inverter 220. If turn-on current It is less than or equal to 0, a recovery current does not flow into freewheel diode D3, which suppresses losses in inverter 220.

Since turn-on current It varies when the drive frequency (switching frequency) of inverter 220 varies, turn-on current It can be controlled by adjusting the drive frequency (switching frequency) of inverter 220. Therefore, in this first embodiment, power supply ECU 250 executes the turn-on current control for controlling turn-on current It to a target value by adjusting the drive frequency (switching frequency) of inverter 220. The target value for turn-on current It is set at a value of less than or equal to 0 such that a recovery current is not produced in inverter 220.

FIG. 5 is a control block diagram of transmission power control and turn-on current control executed by power supply ECU 250. Referring to FIG. 5, power supply ECU 250 includes subtraction units 410, 430 and controllers 420, 440. A feedback loop formed by subtraction unit 410, controller 420 and inverter 220 of a control target implements the transmission power control. On the other hand, a feedback loop formed by subtraction unit 430, controller 440 and inverter 220 implements the turn-on current control.

Subtraction unit 410 subtracts a detected value of transmission power Ps from target power Psr indicating the target value for transmission power, and outputs a calculated value to controller 420. The detected value of transmission power Ps can be calculated based on the detected values of voltage sensor 270 and current sensor 272 shown in FIG. 1, for example.

Controller 420 produces a duty command value for output voltage Vo of inverter 220 based on the deflection between target power Psr and transmission power Ps. Controller 420 calculates a manipulated variable by, for example, executing PI control (proportional plus integral control) using the deflection between target power Psr and transmission power Ps as an input, and uses the calculated manipulated variable as the duty command value. Accordingly, the duty of output voltage Vo is adjusted such that transmission power Ps approaches target power Psr, so that transmission power Ps is controlled to target power Psr.

On the other hand, subtraction unit 430 subtracts a detected value of turn-on current It from a turn-on current target value Itr, and outputs a calculated value to controller 440. Turn-on current target value Itr is set at a value of less than or equal to 0 as described above. The detected value of turn-on current It is a detected value (instantaneous value) of current sensor 272 (FIG. 1) at the time when the rising of output voltage Vo is detected by voltage sensor 270 (FIG. 1).

Controller 440 produces a command value for the drive frequency (switching frequency) of inverter 220 based on the deflection between turn-on current target value Itr and turn-on current It. Controller 440 calculates a manipulated variable by, for example, executing PI control using the deflection between turn-on current target value Itr and turn-on current It as an input, and uses the calculated manipulated variable as the above-described frequency command value. Accordingly, the drive frequency of inverter 220 is adjusted such that turn-on current It approaches target value Itr, so that turn-on current It is controlled to target value Itr.

The transmission power control for adjusting the duty of output voltage Vo of inverter 220 and the turn-on current control for adjusting the drive frequency of inverter 220 interfere with each other, and turn-on current It may not be able to be controlled to target value Itr of less than or equal to 0 depending on the duty adjusted by the transmission power control.

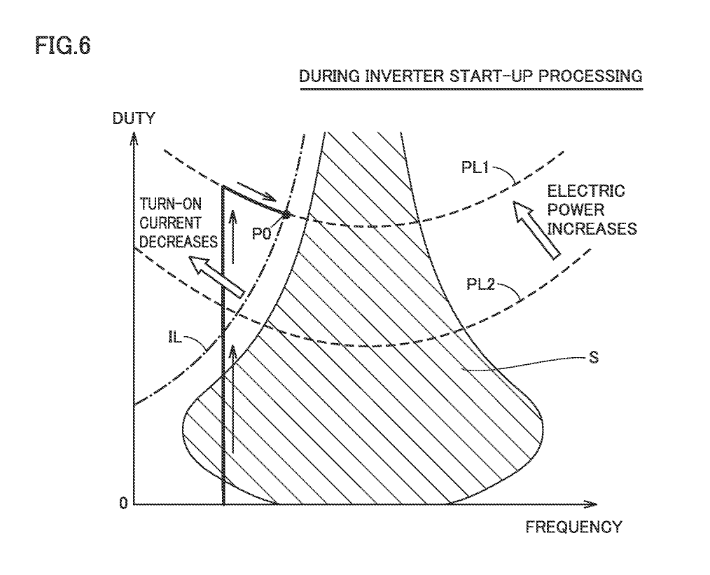

FIG. 6 illustrates an example of contour lines of transmission power Ps and turn-on current It. Referring to FIG. 6, the horizontal axis indicates the drive frequency (switching frequency) of inverter 220, and the vertical axis indicates the duty of output voltage Vo of inverter 220.

Each of lines PL1 and PL2 indicated by the dotted lines represents the contour line of transmission power Ps. The transmission power indicated by line PL1 is larger than the transmission power indicated by line PL2. As seen from the drawing, the duty that achieves certain transmission power indicates frequency dependence. A line IL indicated by the alternate long and short dash line indicates the contour line of a turn-on current. Line IL shown is the contour line of a turn-on current of a certain negative value, and the turn-on current decreases (increases in the negative direction) as the duty increases and the frequency decreases.

A shaded area S is an area where the turn-on current cannot be controlled to be less than or equal to 0 (i.e., the area where a recovery current is produced). That is, when the operating point of inverter 220 is included in area S, even if turn-on current target value Itr is set at a negative value, turn-on current It cannot be controlled to have negative target value Itr by the turn-on current control (hereinafter, area S will also be called a “forbidden band S”).

This forbidden band S tends to be extended when the duty is small, as shown. Therefore, it is desirable to operate inverter 220 such that the operating point passes through this forbidden band S as quickly as possible or avoids forbidden band S as much as possible when inverter 220 is started up (at the rising of transmission power by which the duty increases from 0) or stopped (at the falling of transmission power by which the duty drops to 0).

Therefore, when the startup processing of inverter 220 is executed, power transmission device 10 according to this first embodiment shall execute the transmission power control and the turn-on current control such that the responsivity of the transmission power control (duty adjustment) becomes higher than that of the turn-on current control (frequency adjustment). Specifically, when the startup processing of inverter 220 is executed, the control gain of the transmission power control (gain of controller 420 (FIG. 5)) is made higher than that of the turn-on current control (gain of controller 440 (FIG. 5)). Accordingly, at the time when the startup processing of inverter 220 is executed, the duty can be increased quickly to allow the operating point to pass through forbidden band S as quickly as possible, as shown by the transition of the operating point indicated by the bold line in FIG. 6.

In FIG. 6, an operating point P0 is an initial target value of the operating point of inverter 220, and the time when the startup processing of inverter 220 is executed can be defined as a period during which inverter 220 starts operating and the operating point reaches P0 (a period indicated by the bold line), for example.

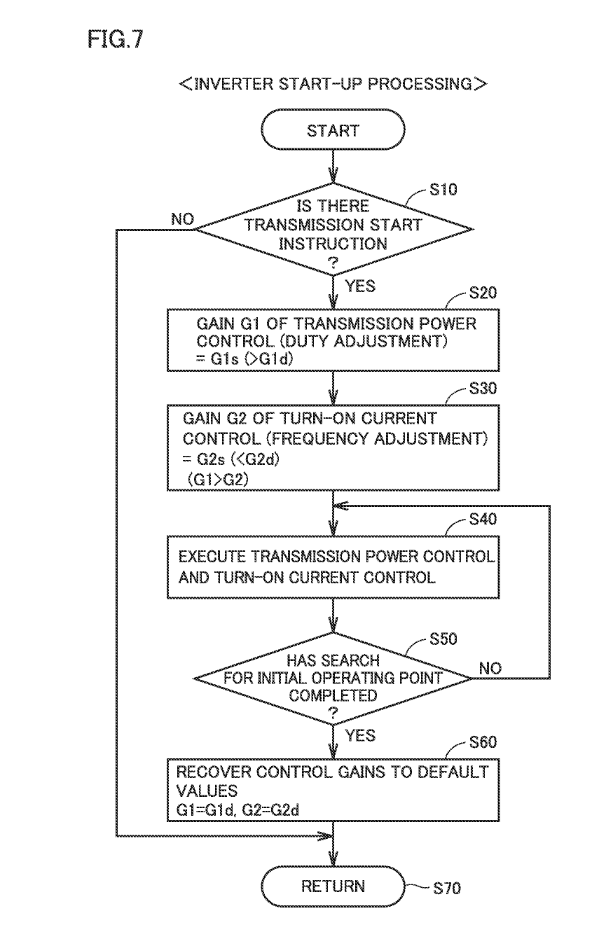

FIG. 7 is a flowchart showing a procedure of inverter startup processing executed by power supply ECU 250. The process shown in this flowchart is invoked for execution from a main routine at predetermined intervals or when predetermined conditions are met.

Referring to FIG. 7, power supply ECU 250 determines whether or not there is a power transmission start instruction sent from power transmission device 10 to power reception device 20 (step S10). This power transmission start instruction may be based on a user instruction made in power transmission device 10 or power reception device 20, or may be produced following the arrival of a charging start time indicated by a timer or the like. When there is no power transmission start instruction (NO in step S10), power supply ECU 250 advances the process to step S70 without executing a series of subsequent operations.

When a determination is made that there is a power transmission start instruction in step S10 (YES in step S10), power supply ECU 250 sets a gain G1 of the transmission power control (duty adjustment) at G1s (step S20). This value G1s is larger than a default value G1d (normal value) of gain G1.

Then, power supply ECU 250 sets a gain G2 of the turn-on current control (frequency adjustment) at G2s (step S30). This value G2s is lower than a default value G2d (normal value) of gain G2.

Here, gain G1 (value G1s) of the transmission power control set in step S20 is higher than gain G2 (value G2s) of the turn-on current control set in step S30. Accordingly, in the startup processing of inverter 220, the responsivity of the transmission power control is made higher than that of the turn-on current control.

Then, power supply ECU 250 executes the transmission power control with gain G1 set in step S20, and executes the turn-on current control with gain G2 set in step S30 (step S40). When each control is started, power supply ECU 250 determines whether or not the operating point of inverter 220 has reached an initial operating point (P0 in FIG. 6) (step S50). This initial operating point is equivalent to target power Psr for the transmission power control and target value Itr for the turn-on current control at the time when the inverter startup processing is executed.

Power supply ECU 250 returns the process to step S40 until the operating point of inverter 220 reaches the initial operating point (NO in step S50). When a determination is made that the operating point of inverter 220 has reached the initial operating point (YES in step S50), power supply ECU 250 causes the respective gains in the transmission power control and the turn-on current control to recover to their default values (normal values) (step S60). That is, power supply ECU 250 changes gain G1 of the transmission power control to default value G1d, and gain G2 of the turn-on current control to default value G2d.

As described above, in this first embodiment, the responsivity of the transmission power control is made higher than that of the turn-on current control at the time when the startup processing of inverter 220 is executed. Accordingly, at the time when the startup processing of inverter 220 is executed, the duty can be raised quickly from 0 to allow the operating point of inverter 220 to pass quickly through forbidden band S (FIG. 6). Therefore, according to this first embodiment, a recovery current can be prevented from flowing into inverter 220 as much as possible at the time when the startup processing of inverter 220 is executed.

### Second Embodiment

In this second embodiment, the control gain of the turn-on current control is made higher than that of the transmission power control at the time when the stop processing of inverter 220 is executed. Accordingly, at the time when the stop processing of inverter 220 is executed, the duty can be reduced to reduce transmission power while avoiding forbidden band S as much as possible.

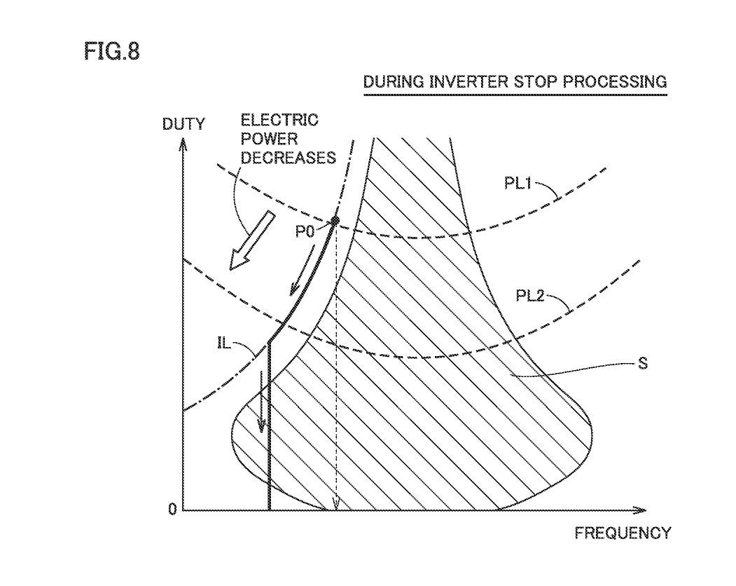

FIG. 8 illustrates an example of contour lines of transmission power Ps and turn-on current It. Referring to FIG. 8, this drawing corresponds to FIG. 6 described in the first embodiment, and the transition of the inverter operating point at the time when the stop processing of inverter 220 is executed is indicated by the bold line.

Although the duty is reduced to 0 by the transmission power control at the time when the stop processing of inverter 220 is executed, the period during which the operating point passes through forbidden band S may be extended if the duty is reduced without varying the frequency from operating point P0.

Therefore, power transmission device 10 according to this second embodiment shall execute the transmission power control and the turn-on current control at the time when the stop processing of inverter 220 is executed such that the responsivity of the turn-on current control (frequency adjustment) becomes higher than that of the transmission power control (duty adjustment). Specifically, at the time when the stop processing of inverter 220 is executed, the control gain of the turn-on current control (gain of controller 440 in FIG. 5) is made higher than that of the transmission power control (gain of controller 420 in FIG. 5). Accordingly, at the time when the stop processing of inverter 220 is executed, the operating point transitions while avoiding forbidden band S, and a recovery current produced in forbidden band S can be suppressed as much as possible, as shown by the transition of the operating point indicated by the bold line in FIG. 8.

The overall configuration of the power transfer system, the circuit configuration of power transmission unit 240 and power reception unit 310, the circuit configuration of inverter 220, and the configuration of the control block of the transmission power control and the turn-on current control according to this second embodiment are identical to those of the first embodiment described above.

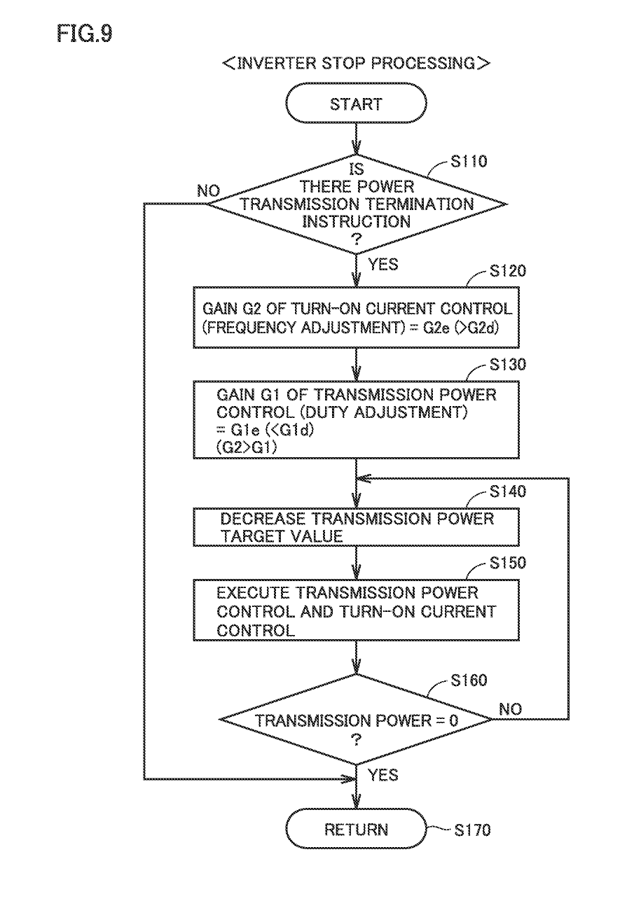

FIG. 9 is a flowchart showing a procedure of inverter stop processing executed by power supply ECU 250 according to the second embodiment. The process shown in this flowchart is also invoked for execution from a main routine at predetermined intervals or when predetermined conditions are met.

Referring to FIG. 9, power supply ECU 250 determines whether or not there is a power transmission termination instruction sent from power transmission device 10 to power reception device 20 (step S110). This power transmission termination instruction may also be based on a user instruction made in power transmission device 10 or power reception device 20, or may also be produced following the arrival of a charging termination time indicated by a timer or the like. When there is no power transmission termination instruction (NO in step S110), power supply ECU 250 advances the process to step S170 without executing a series of subsequent operations.

When a determination is made that there is a power transmission termination instruction in step S110 (YES in step S110), power supply ECU 250 sets gain G2 of the turn-on current control (frequency adjustment) at G2e (step S120). This value G2e is larger than default value G2d (normal value) of gain G2.

Then, power supply ECU 250 sets gain G1 of the transmission power control (duty adjustment) at G1e (step S130). This value G1e is lower than default value G1d (normal value) of gain G1.

Here, gain G2 (value G2e) of the turn-on current control set in step S120 is higher than gain G1 (value G1e) of the transmission power control set in step S130. Accordingly, in the stop processing of inverter 220, the responsivity of the turn-on current control is made higher than that of the transmission power control.

Then, power supply ECU 250 decreases the target value for transmission power (target power Psr) in the transmission power control (step S140), and executes the transmission power control with gain G1 set in step S130 and the turn-on current control with gain G2 set in step S120 (step S150).

Then, power supply ECU 250 determines whether or not transmission power Ps has reached 0 (step S160). This determination should just be made as to whether or not transmission power Ps has reached substantially 0. Power supply ECU 250 returns the process to step S140 until transmission power Ps reaches 0 (NO in step S160). When a determination is made that transmission power Ps has reached 0 (YES in step S160), power supply ECU 250 advances the process to step S170.

Although not particularly shown, if the frequency reaches the lower limit during execution of the turn-on current control in step S150, the target value (target power Psr) for transmission power may be immediately set at 0, and gain G1 of the transmission power control may be changed to a higher value, since the frequency adjustment is no longer possible. Accordingly, the duty and transmission power can be promptly reduced to 0.

As described above, in this second embodiment, the responsivity of the turn-on current control is made higher than that of the transmission power control at the time when the stop processing of inverter 220 is executed. Accordingly, at the time when the stop processing of inverter 220 is executed, the duty can be reduced to reduce transmission power while avoiding forbidden band S (FIG. 8) as much as possible. Therefore, according to this second embodiment, a recovery current can be prevented from flowing into inverter 220 as much as possible at the time when the stop processing of inverter 220 is executed.

In the above-described first and second embodiments, the control gain of each control shall be changed in changing the responsivities of the transmission power control and the turn-on current control, but the allowable value for the change rate of the control manipulated variable may be changed instead of the control gain. For example, for the first embodiment, the allowable value for the change rate of the manipulated variable (duty command value) calculated in the transmission power control may be made higher than the allowable value for the change rate of the manipulated variable (frequency command value) calculated in the turn-on current control at the time when the stop processing of inverter 220 is executed. For the second embodiment, the allowable value for the change rate of the manipulated variable (frequency command value) calculated in the turn-on current control may be made higher than the allowable value for the change rate of the manipulated variable (duty command value) calculated in the transmission power control at the time when the stop processing of inverter 220 is executed.

In the above description, power supply ECU 250 corresponds to an embodiment of “a control unit” according to the present invention. The transmission power control corresponds to “a first control” according to the present invention, and the turn-on current control corresponds to “a second control” according to the present invention.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A contactless power transmission device, comprising:
a power transmission unit configured to transmit electric power to a power reception device in a contactless manner;
a voltage-source inverter configured to supply transmission power in accordance with a drive frequency to the power transmission unit; and
a control unit configured to control the inverter,
the control unit executing
a first control for controlling the transmission power to target power by adjusting a duty of an output voltage of the inverter, and
a second control for controlling a turn-on current by adjusting the drive frequency, the turn-on current indicating an output current of the inverter at a rising of the output voltage,
the control unit executing the first and second controls such that a responsivity of the first control becomes higher than a responsivity of the second control during the execution of startup processing of the inverter.

2. The contactless power transmission device according to claim 1, wherein the control unit makes a control gain of the first control higher than a control gain of the second control during the execution of the startup processing.

3. The contactless power transmission device according to claim 1, wherein the control unit further executes the first and second controls such that the responsivity of the second control becomes higher than the responsivity of the first control during the execution of stop processing of the inverter.

4. The contactless power transmission device according to claim 3, wherein the control unit makes a control gain of the second control higher than a control gain of the first control during the execution of the stop processing.

5. The contactless power transmission device according to claim 1, wherein the control unit executes the first and second controls such that the responsivity of the first control during the execution of the startup processing becomes higher than the responsivity of the first control during the execution of stop processing of the inverter.

6. The contactless power transmission device according to claim 5, wherein the control unit makes a control gain of the first control during the execution of the startup processing higher than a control gain of the first control during the execution of the stop processing.

7. The contactless power transmission device according to claim 1, wherein the control unit executes the first and second controls such that the responsivity of the second control during the execution of stop processing of the inverter becomes higher than the responsivity of the second control during the execution of the startup processing.

8. The contactless power transmission device according to claim 7, wherein the control unit makes a control gain of the second control during the execution of the stop processing higher than a control gain of the second control during the execution of the startup processing.

9. A power transfer system, comprising:
a power transmission device; and
a power reception device,
the power transmission device including
a power transmission unit configured to transmit electric power to the power reception device in a contactless manner,
a voltage-source inverter configured to supply transmission power in accordance with a drive frequency to the power transmission unit, and
a control unit configured to control the inverter, the control unit executing
a first control for controlling the transmission power to target power by adjusting a duty of an output voltage of the inverter, and
a second control for controlling a turn-on current to a target value by adjusting the drive frequency, the turn-on current indicating an output current of the inverter at a rising of the output voltage,
the target value being set to fall within a range where a recovery current is not produced in a freewheel diode of the inverter,
the control unit executing the first and second controls such that a responsivity of the first control becomes higher than a responsivity of the second control during the execution of startup processing of the inverter.

10. The power transfer system according to claim 9, wherein the control unit further executes the first and second controls such that the responsivity of the second control becomes higher than the responsivity of the first control during the execution of stop processing of the inverter.

11. The power transfer system according to claim 9, wherein the control unit executes the first and second controls such that the responsivity of the first control during the execution of the startup processing becomes higher than the responsivity of the first control during the execution of stop processing of the inverter.

12. The power transfer system according to claim 9, wherein the control unit executes the first and second controls such that the responsivity of the second control during the execution of stop processing of the inverter becomes higher than the responsivity of the second control during the execution of the startup processing.
